(19) United States
(12) Patent Application Publication
(10) Pub. No.: US 2025/0308438 A1
(43) Pub. Date: Oct. 2, 2025

(54) SUB-PIXEL AND DISPLAY DEVICE HAVING THE SAME

(71) Applicant: Samsung Display Co., LTD., Yongin-si (KR)

(72) Inventor: Jung Hwan HWANG, Yongin-si (KR)

(73) Assignee: Samsung Display Co., LTD., Yongin-si (KR)

(21) Appl. No.: 19/010,656

(22) Filed: Jan. 6, 2025

(30) Foreign Application Priority Data
Mar. 27, 2024 (KR) 10-2024-0041650

(51) Int. Cl. G09G 3/32

(52) U.S. Cl. CPC G09G 3/32; G09G 2300/0465; G09G 2310/08; G09G 2320/064

(57) ABSTRACT

A display device includes a first transistor generating a first driving current corresponding to a data voltage, a first capacitor including a first electrode receiving a sweep voltage and a second electrode connected to a control electrode of the first transistor, a driving transistor generating a second driving current, a second capacitor including a first electrode connected to the first transistor and a second electrode connected to a control electrode of the driving transistor, and a light emitting element receiving the second driving current to emit light.

### CROSS-REFERENCE TO RELATED APPLICATION(S)

The application claims priority under 35 U.S.C. § 119 to and benefits of Korean Patent Application No. 10-2024-0041650 filed on Mar. 27, 2024 in the Korean Intellectual Property Office, the entire contents of which are incorporated herein by reference.

### BACKGROUND

### 1. Technical Field

The disclosure generally relates to a sub-pixel and a display device having the same.

### 2. Description of the Related Art

With the development of information technologies, the importance of a display device which is a connection medium between a user and information increases. Accordingly, display devices such as a liquid crystal display device, an organic light emitting display device, and an inorganic light emitting display device are increasingly being used.

Recently, studies on micro LEDs which have a high response speed and can implement a high luminance as compared with the existing LEDs have been actively conducted. In the case of inorganic light emitting elements such as micro LEDs, in case that a Pulse Amplitude Modulation (PAM) pixel driving method is used as with organic LEDs, it may be difficult to accurately implement a desired luminance as the peak wavelength varies according to a current density. Therefore, in the case of micro LEDs, a Pulse Width Modulation (PWM) pixel driving method may be used in which a luminance is expressed by controlling the time for which a current flows through a light emitting element.

### SUMMARY

Embodiments provide a sub-pixel driven using a PWM method.

Embodiments also provide a display device having the sub-pixel.

In accordance with an aspect of the disclosure, there is provided a sub-pixel that may include a first transistor generating a first driving current corresponding to a data voltage; a first capacitor including a first electrode receiving a sweep voltage and a second electrode connected to a control electrode of the first transistor; a driving transistor generating a second driving current; a second capacitor including a first electrode connected to the first transistor and a second electrode connected to a control electrode of the driving transistor; and a light emitting element receiving the second driving current to emit light.

The sub-pixel may further include a second transistor providing the data voltage to the first transistor in response to a write gate signal; a third transistor allowing the first transistor to be diode-connected in response to a first compensation gate signal; a fourth transistor providing a first power voltage to the first transistor in response to a first emission signal; and a reset transistor providing an initialization voltage to the first transistor in response to a second emission signal.

The first transistor may include the control electrode connected to the first capacitor, a first electrode connected to the second capacitor, and a second electrode. The second transistor may be connected to the second electrode of the first transistor. The third transistor may be connected to the control electrode of the first transistor and the first electrode of the first transistor. The fourth transistor may be connected to the first electrode of the first transistor. The reset transistor may be connected to the second electrode of the first transistor.

The second transistor may be an N-type transistor.

The second transistor may be a P-type transistor.

The third transistor may be an N-type transistor.

The sub-pixel may include a compensation transistor allowing the driving transistor to be diode-connected in response to a second compensation gate signal; an initialization transistor providing an initialization voltage to the driving transistor in response to an initialization gate signal; an emission control transistor connecting the driving transistor to the light emitting element in response to a second emission signal; and a discharge transistor providing a second power voltage to an anode electrode of the light emitting element in response to a first emission signal.

The driving transistor may include the control electrode connected to the second capacitor, a first electrode receiving a first power voltage, and a second electrode. The compensation transistor may be connected to the control electrode of the driving transistor and the second electrode of the driving transistor. The initialization transistor may be connected to the control electrode of the driving transistor.

The driving transistor may include the control electrode connected to the second capacitor, a first electrode receiving a first power voltage, and a second electrode. The compensation transistor may be connected to the control electrode of the driving transistor and the second electrode of the driving transistor. The initialization transistor may be connected to the second electrode of the driving transistor.

The compensation transistor may be an N-type transistor.

The first transistor may be an N-type transistor, and the driving transistor may be a P-type transistor.

The sub-pixel may further include a third capacitor including a first electrode receiving a first power voltage and a second electrode connected to the control electrode of the driving transistor.

In accordance with another aspect of the disclosure, there may be provided a display device that may include a display panel including at least one sub-pixel; and a display panel driver configured to drive the display panel, wherein each of the at least one sub-pixel may include a first transistor generating a first driving current corresponding to a data voltage; a first capacitor including a first electrode receiving a sweep voltage and a second electrode connected to a control electrode of the first transistor; a driving transistor generating a second driving current; a second capacitor including a first electrode connected to the first transistor and a second electrode connected to a control electrode of the driving transistor; and a light emitting element receiving the second driving current to emit light.

Each of the at least one sub-pixel may further include a reset transistor providing an initialization voltage to the first transistor in response to a second emission signal; and an initialization transistor providing the initialization voltage to the driving transistor in response to an initialization gate signal. The initialization voltage may be determined according to a grayscale.

The initialization voltage may have a first voltage in case that the grayscale has a first grayscale, and have a second voltage higher than the first voltage in case that the grayscale has a second grayscale smaller than the first grayscale.

A frame may include a first sub-frame and at least one second sub-frame. The light emitting element may emit light in the at least one second sub-frame. A number of the at least one second sub-frame may be determined according to an emission frequency.

The at least one sub-pixel may include a plurality of sub-pixels. The plurality of sub-pixels may be arranged in a plurality of rows. The display panel driver may be configured to allow ones of the plurality of sub-pixels disposed in a first portion of the plurality of rows to emit light and then allow ones of the plurality of sub-pixels disposed in a second portion of the plurality of rows to emit light.

The at least one sub-pixel may include a plurality of sub-pixels, the plurality of sub-pixels may be disposed in a plurality of rows. The display panel driver may be configured to allow the plurality of sub-pixels included in the plurality of rows to sequentially emit light at a first emission frequency, and the display panel driver may be further configured to allow ones of the plurality of sub-pixels disposed in a first portion of the plurality of rows to emit light and then allow ones of the plurality of sub-pixels disposed in a second portion of the plurality of rows to emit light at a second emission frequency higher than the first emission frequency.

Each of the at least one sub-pixel may include a second transistor providing the data voltage to the first transistor in response to a write gate signal; a third transistor allowing the first transistor to be diode-connected in response to a first compensation gate signal; a fourth transistor providing a first power voltage to the first transistor in response to a first emission signal; a reset transistor providing an initialization voltage to the first transistor in response to a second emission signal; a compensation transistor allowing the driving transistor to be diode-connected in response to a second compensation gate signal; an initialization transistor providing the initialization voltage to the driving transistor in response to an initialization gate signal; an emission control transistor connecting the compensation transistor to the light emitting element in response to the second emission signal; and a discharge transistor providing a second power voltage to an anode electrode of the light emitting element in response to the first emission signal.

The at least one sub-pixel may further include a third capacitor including a first electrode receiving the first power voltage and a second electrode connected to the control electrode of the driving transistor.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a schematic block diagram illustrating an embodiment of a display device.

FIG. 2 is a schematic block diagram illustrating an embodiment of any one of sub-pixels shown in FIG. 1.

FIG. 3 is a schematic diagram of an equivalent circuit of the one of sub-pixels shown in FIG. 1.

FIG. 4 is a schematic diagram illustrating a driving operation of the display device shown in FIG. 1.

FIG. 5 is a schematic timing diagram illustrating an example in which the display device shown in FIG. 1 performs a display scan operation.

FIG. 6 is a schematic timing diagram illustrating an example in which the display device shown in FIG. 1 performs a self-scan operation.

FIGS. 7 to 9 are schematic diagrams illustrating an example in which a display device controls an emission time according to an emission frequency in accordance with embodiments of the disclosure.

FIG. 10 is a table illustrating an example in which a display device adjusts an initialization voltage according to a grayscale in accordance with embodiments of the disclosure.

FIG. 11 is a graph illustrating an example of a second driving current according to the grayscale shown in FIG. 10.

FIG. 12 is a schematic diagram of an equivalent circuit of any one of sub-pixels of a display device in accordance with embodiments of the disclosure.

FIG. 13 is a schematic timing diagram illustrating an example in which the display device shown in FIG. 12 drives a first sub-frame of a frame in which a display scan operation is performed.

FIG. 14 is a schematic diagram of an equivalent circuit of any one of sub-pixels of a display device in accordance with embodiments of the disclosure.

FIG. 15 is a schematic timing diagram illustrating an example in which the display device shown in FIG. 14 drives a first sub-frame of a frame in which a display scan operation is performed.

FIG. 16 is a schematic block diagram illustrating an embodiment of a display system.

FIGS. 17 to 20 are perspective views illustrating application examples of the display system shown in FIG. 16.

### DETAILED DESCRIPTION OF THE EMBODIMENTS

In the following description, for the purposes of explanation, numerous specific details are set forth in order to provide a thorough understanding of various embodiments or implementations of the disclosure. As used herein “embodiments” and “implementations” are interchangeable words that are non-limiting examples of devices or methods disclosed herein. It is apparent, however, that various embodiments may be practiced without these specific details or with one or more equivalent arrangements. Here, various embodiments do not have to be exclusive nor limit the disclosure. For example, specific shapes, configurations, and characteristics of an embodiment may be used or implemented in another embodiment.

Unless otherwise specified, the illustrated embodiments are to be understood as providing features of the disclosure. Therefore, unless otherwise specified, the features, components, modules, layers, films, panels, regions, and/or aspects, etc., (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals and/or reference characters denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the X-axis, the Y-axis, and the Z-axis are not limited to three axes of a rectangular coordinate system, such as the x, y, and z axes, and may be interpreted in a broader sense. For example, the X-axis, the Y-axis, and the Z-axis may be perpendicular to one another, or may be different directions that are not perpendicular to one another.

For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Although the terms “first,” “second,” etc., may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, parts, and/or modules. Those skilled in the art will appreciate that these blocks, parts, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, parts, and/or modules being implemented by microprocessors or other similar hardware, they may be programmed and controlled using software (e.g., microcode) to perform various functions discussed herein and may optionally be driven by firmware and/or software. It is also contemplated that each block, part, and/or module may be implemented by dedicated hardware, or as a combination of dedicated hardware to perform some functions and a processor (e.g., one or more programmed microprocessors and associated circuitry) to perform other functions. Also, each block, part, and/or module of some embodiments may be physically separated into two or more interacting and discrete blocks, parts, and/or modules without departing from the scope of the inventive concepts. Further, the blocks, parts, and/or modules of some embodiments may be physically combined into more complex blocks, parts, and/or modules without departing from the scope of the inventive concepts.

Unless otherwise defined or implied herein, all terms (including technical and scientific terms) used herein have the same meaning as commonly understood by those skilled in the art to which this disclosure pertains. It will be further understood that terms, such as those defined in commonly used dictionaries, should be interpreted as having a meaning that is consistent with their meaning in the context of the relevant art and the disclosure, and should not be interpreted in an ideal or excessively formal sense unless clearly so defined herein.

Hereinafter, embodiments of the disclosure will be described in detail with reference to the accompanied drawings.

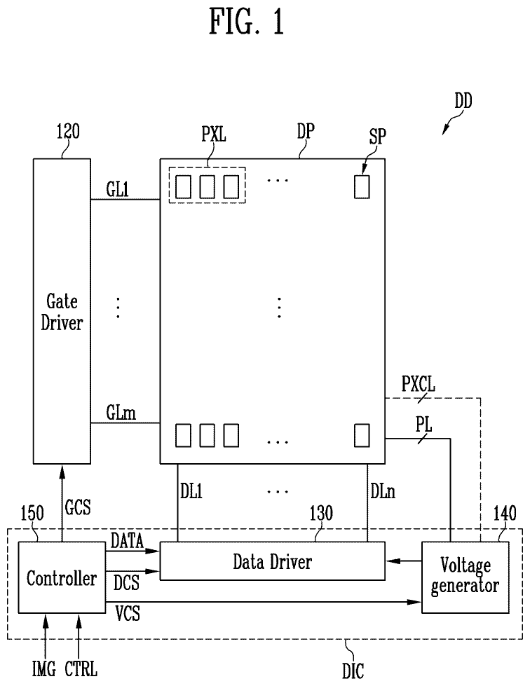

FIG. 1 is a schematic block diagram illustrating an embodiment of a display device.

Referring to FIG. 1, the display device DD may include a display panel DP and a display panel driver. The display panel driver may include a gate driver 120, a data driver 130, a voltage generator 140, and a controller 150.

The display panel DP may include sub-pixels SP. The sub-pixels SP may be connected to the gate driver 120 through first to mth gate lines GL1 to GLm. The sub-pixels SP may be connected to the data driver 130 through first to nth data lines DL1 to DLn.

The sub-pixels SP may generate light of two or more colors. For example, each of the sub-pixels SP may generate light of red, green, blue, cyan, magenta, yellow, white, and the like.

Two or more sub-pixels among the sub-pixels SP may constitute a pixel PXL. For example, the pixel PXL may include three sub-pixels as shown in FIG. 1. As such, the pixel PXL may emit light of various colors with various luminances according to a combination of light emitted from the sub-pixels included therein.

The gate driver 120 may be connected to the sub-pixels SP arranged in a row direction through the first to mth gate lines GL1 to GLm. The gate driver 120 may output gate signals to the first to mth gate lines GL1 to GLm in response to a gate control signal GCS. In embodiments, the gate control signal GCS may include a start signal indicating a start of each frame, a horizontal synchronization signal, and the like.

The gate signals may include a first emission signal, a second emission signal, a first compensation signal, a second compensation signal, and an initialization gate signal, which will be described later.

The gate driver 120 may be disposed at a side of the display panel DP. However, embodiments are not limited thereto. For example, the gate driver 120 may be divided into two or more drivers which may be physically and/or logically divided, and these drivers may be disposed at a side of the display panel DP and another side of the display panel DP which is opposite to the side. As such and in some embodiments, the gate driver 120 may be disposed in various forms at the periphery of the display panel DP.

The data driver 130 may be connected to the sub-pixels SP arranged in a column direction through the first to nth data lines DL1 to DLn. The data driver 130 may receive image data DATA and a data control signal DCS from the controller 150. The data driver 130 may operate in response to the data control signal DCS. In embodiments, the data control signal DCS may include a source start pulse, a source shift clock, a source output enable signal, and the like.

The data driver 130 may receive voltages from the voltage generator 140. The data driver 130 may apply data signals having grayscale voltages corresponding to the image data DATA to the first to nth data lines DL1 to DLn by using the received voltages. In case that a gate signal is applied to each of the first to mth gate lines GL1 to GLm, data signals corresponding to the image data DATA may be applied to the first to nth data line DL1 to DLm. Accordingly, corresponding sub-pixels SP may generate light corresponding to the data signals. Accordingly, an image may be displayed on the display panel DP.

In embodiments, the gate driver 120 and the data driver 130 may include complementary metal-oxide semiconductor (CMOS) circuit elements.

The voltage generator 140 may operate in response to a voltage control signal VCS from the controller 150. The voltage generator 140 may be configured to generate multiple voltages and provide the generated voltages to components of the display device DD. The voltage generator 140 may generate multiple voltages by receiving an input voltage from the outside of the display device DD and regulating the received voltage.

The voltage generator 140 may generate a first power voltage and a second power voltage. The generated first and second power voltages may be provided to the sub-pixels SP through power lines PL. In other embodiments, at least one of the first and second power voltages may be provided from the outside of the display device DD.

Besides, the voltage generator 140 may further provide various voltages and/or signals. For example, the voltage generator 140 may provide one or more initialization voltages applied to the sub-pixels SP. For example, in a sensing operation for sensing electrical characteristics of transistors and/or light emitting elements of the sub-pixels SP, a reference voltage (e.g., predetermined or selectable reference voltage) may be applied to the first to nth data lines DL1 to DLn, and the voltage generator 140 may generate the reference voltage and transfer the reference voltage to the data driver 130. For example, in a display operation for displaying an image on the display panel DP, common pixel control signals may be applied to the sub-pixels SP, and the voltage generator 140 may generate the pixel control signals. In embodiments, the voltage generator 140 may provide the pixel control signals to the sub-pixels SP through pixel control lines PXCL. In FIG. 1, it is illustrated that the pixel control lines PXCL are connected between the voltage generator 140 and the display panel DP. However, embodiments are not limited thereto. For example, the pixel control lines PXCL may be connected between the gate driver 120 and the display panel DP. The pixel control signals may be transferred to the pixel control lines PXCL from the voltage generator 140 through the gate driver 120.

The controller 150 may control overall operations of the display device DD. The controller 150 may receive from the outside input image data IMG and a control signal CTRL corresponding thereto. The controller 150 may provide the gate control signal GCS, the data control signal DCS, and the voltage control signal VCS in response to the control signal CTRL.

The controller 150 may convert the input image data IMG to be suitable for the display device DD or the display panel DP, thereby outputting the image data DATA. In embodiments, the controller 150 may align the input image data IMG to be suitable for the sub-pixels SP in units of rows, thereby outputting the image data DATA.

Two or more components among the data driver 130, the voltage generator 140, and the controller 150 may be mounted on an integrated circuit (e.g., single integrated circuit). As shown in FIG. 1, the data driver 130, the voltage generator 140, and the controller 150 may be included in a driver integrated circuit DIC. The data driver 130, the voltage generator 140, and the controller 150 may be components functionally divided in a driver integrated circuit DIC. In other embodiments, at least one of the data driver 130, the voltage generator 140, and the controller 150 may be provided as a component distinguished from the driver integrated circuit DIC.

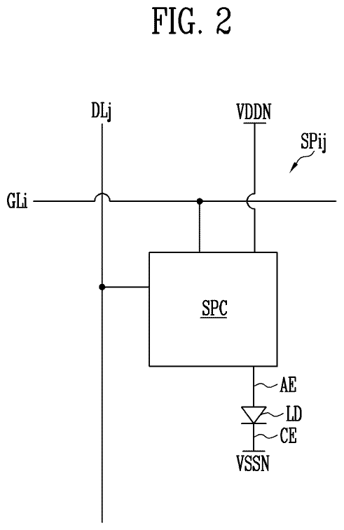

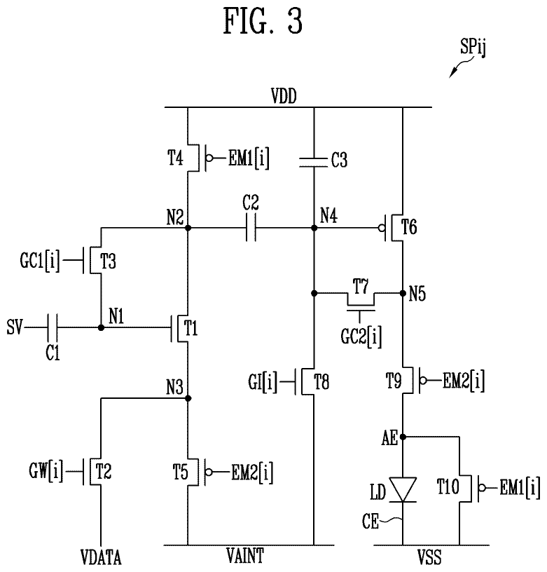

FIG. 2 is a schematic block diagram illustrating an embodiment of any one of the sub-pixels shown in FIG. 1. FIG. 3 is a schematic diagram of an equivalent circuit of the one of sub-pixels shown in FIG. 1. In FIG. 2, a sub-pixel SPij arranged on an ith row (i may be an integer greater than or equal to 1 and smaller than or equal to m) and a jth column (j may be an integer greater than or equal to 1 and smaller than or equal to n) among the sub-pixels SP shown in FIG. 1 is illustrated.

Referring to FIG. 2, the sub-pixel SPij may include a sub-pixel circuit SPC and a light emitting element LD.

The light emitting element LD may be connected between a first power voltage node VDDN and a second power voltage node VSSN. The first power voltage node VDDN may be connected to one of the power lines PL shown in FIG. 1 to receive a first power voltage. The second power voltage node VSSN may be connected to another of the power lines PL to receive a second power voltage. The first power voltage may have a voltage level higher than a voltage level of the second power voltage.

The light emitting element LD may be connected between an anode electrode AE and a cathode electrode CE. The anode electrode AE may be connected to the first power voltage node VDDN through the sub-pixel circuit SPC. For example, the anode electrode AE may be connected to the first power voltage node VDDN through one or more transistors included in the sub-pixel circuit SPC. The cathode electrode CE may be connected to the second power voltage node VSSN. The light emitting element LD may be configured to emit light according to a current flowing from the anode electrode AE to the cathode electrode CE.

The sub-pixel circuit SPC may be connected to an ith gate line GLi among the first to mth gate lines GL1 to GLm shown in FIG. 1 and a jth data line DLj among the first to nth data lines DL1 to DLn shown in FIG. 1. In response to a gate signal received through the ith gate line GLi, the sub-pixel circuit SPC controls the light emitting element LD to emit light according to a data signal received through the jth data line DLj. In embodiments, the sub-pixel circuit SPC may be further connected to the pixel control lines PXCL shown in FIG. 1. The sub-pixel circuit SPC may control the light emitting element LD in further response to control signals received through the pixel control lines PXCL.

For these operations, the sub-pixel circuit SPC may include circuit elements, e.g., transistors and one or more capacitors.

The transistors of the sub-pixel circuit SPC may include P-type transistors and/or N-type transistors. In embodiments, the transistors of the sub-pixel circuit SPC may include a Metal Oxide Silicon Field Effect Transistor (MOSFET). In embodiments, the transistors of the sub-pixel circuit SPC may include an amorphous silicon semiconductor, a monocrystalline silicon semiconductor, polycrystalline silicon semiconductor, an oxide semiconductor, and the like.

Referring to FIG. 3, the sub-pixel SPij may include a first transistor T1 which generates a first driving current corresponding to a data voltage VDATA, a second transistor T2 which provides the data voltage VDATA to the first transistor T1 in response to a write gate signal GW[i], a third transistor T3 which allow the first transistor T1 to be diode-connected in response to a first compensation gate signal GC1[i], a fourth transistor T4 which provides a first power voltage VDD to the first transistor T1 in response to a first emission signal EM1[i], a fifth transistor T5 (e.g., reset transistor) which provides an initialization voltage VAINT to the first transistor T1 in response to a second emission signal EM2[i], a first capacitor C1 including a first electrode receiving a sweep voltage SV and a second electrode connected to a control electrode of the first transistor T1, a sixth transistor T6 (e.g., driving transistor) which generates a second driving current, a second capacitor C2 including a first electrode connected to the first transistor T1 and a second electrode connected to a control electrode of the sixth transistor T6, a seventh transistor T7 (e.g., compensation transistor) which allows the sixth transistor T6 to be diode-connected in response to a second compensation gate signal GC2[i], an eighth transistor T8 (e.g., initialization transistor) which provides the initialization voltage VAINT to the sixth transistor T6 in response to an initialization gate signal G1[i], a ninth transistor T9 (e.g., emission control transistor) which connects the sixth transistor T6 to a light emitting element LD in response to a second emission signal EM2[i], a tenth transistor T10 (e.g., discharge transistor) which provides a second power voltage VSS to an anode electrode of the light emitting element LD in response to a first emission signal EM1[i], a third capacitor C3 including a first electrode receiving the first power voltage VDD and a second electrode connected to the control electrode of the sixth transistor T6, and the light emitting element LD which receives the second driving current to emit light.

For example, the first transistor T1 may include the control electrode connected to a first node N1, a first electrode connected to a second node N2, and a second electrode connected to a third node N3, the second transistor T2 may include a control electrode receiving the write gate signal GW[i], a first electrode receiving the data voltage VDATA, and a second electrode connected to the third node N3, the third transistor T3 may include a control electrode receiving the first compensation gate signal GC1[i], a first electrode connected to the second node N2, and a second electrode connected to the first node N1, the fourth transistor T4 may include a control electrode receiving the first emission signal EM1[i], a first electrode receiving the first power voltage VDD, and a second electrode connected to the second node N2, the fifth transistor T5 may include a control electrode receiving the second emission signal EM2[i], a first electrode receiving the initialization voltage VAINT, and a second electrode connected to the third node N3, the sixth transistor T6 may include the control electrode connected to a fourth node N4, the first electrode receiving the first power voltage VDD, and a second electrode connected to a fifth node N5, the seventh transistor T7 (e.g., compensation transistor) may include a control electrode receiving the second compensation gate signal GC2[i], a first electrode connected to the fifth node N5, and a second electrode connected to the fourth node N4, the eighth transistor T8 may include a control electrode receiving the initialization gate signal G1[i], a first electrode receiving the initialization voltage VAINT, and a second electrode connected to the fourth node N4, the ninth transistor T9 may include a control electrode receiving the second emission signal EM2[i], a first electrode connected to the fifth node N5, and a second electrode connected to the anode electrode AE, and the tenth transistor T10 may include a control electrode receiving the first emission signal EM1[i], a first electrode receiving the second power voltage VSS, and a second electrode connected to the anode electrode AE.

For example, the first capacitor C1 may include the first electrode receiving the sweep voltage SV and the second electrode connected to the first node N1, the second capacitor C2 may include the first electrode connected to the second node N2 and a second electrode connected to the fourth node N4, and the third capacitor C3 may include the first electrode receiving the first power voltage VDD and the second electrode connected to the fourth node N4.

As the third capacitor C3 may be connected between the first power voltage VDD and the fourth node N4, a source-gate voltage of the sixth transistor T6 can be maintained even in case that the first power voltage VDD may be lowered by an IR drop. Accordingly, a change in the second driving current due to the IR drop can be compensated.

In an embodiment, the first, second, third, seventh, and eighth transistors T1, T2, T3, T7, and T8 may be implemented with an N-type transistor, and the fourth, fifth, sixth, ninth, and tenth transistors T4, T5, T6, T9, and T10 may be implemented with a P-type transistor. However, the disclosure is not limited to the type of each transistor.

As the first transistor T1 may be configured as the N-type transistor, and the first power voltage VDD may be applied to the first electrode of the sixth transistor T6, a luminance change caused by hysteresis characteristics of the first and sixth transistors T1 and T6 can be minimized.

As such, the sub-pixel SPij may be driven with only a small number of transistors using a PWM method which will be described later so that the display device can secure a high pixel per inch (PPI).

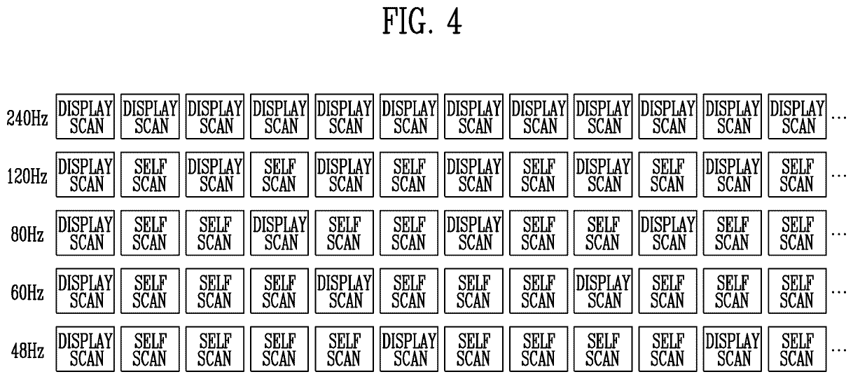

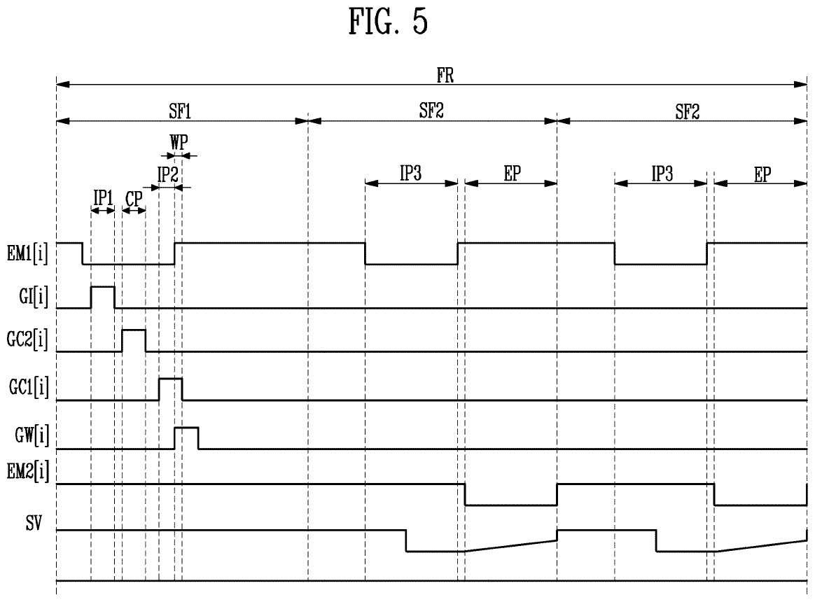

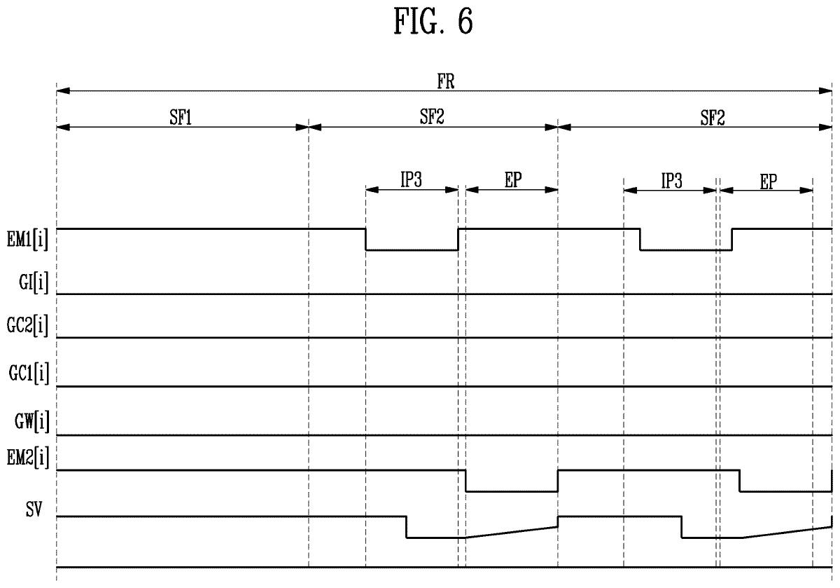

FIG. 4 is a schematic diagram illustrating a driving operation of the display device shown in FIG. 1. FIG. 5 is a schematic timing diagram illustrating an example in which the display device shown in FIG. 1 performs a display scan operation. FIG. 6 is a schematic timing diagram illustrating an example in which the display device shown in FIG. 1 performs a self-scan operation.

Referring to FIGS. 1, 3, and 4, a display scan operation DISPAY SCAN or a self-scan operation SELF SCAN may be performed in a frame (e.g., single frame). A write operation of a data voltage VDATA may be performed in case that the display scan operation DISPLAY SCAN is performed, and a light emission operation may be performed without writing the data voltage VDATA in case that the self-scan operation SELF SCAN is performed.

At a maximum driving frequency of the display panel DP (e.g., in case that a driving frequency is 240 Hz), a display scan operation DISPLAY SCAN of a frame (e.g., single frame) may be successively repeated. A display scan operation DISPLAY SCAN of a frame (e.g., single frame) may constitute a driving frame (e.g., single driving frame).

At driving frequencies (i.e., 120 Hz, 80 Hz, 60 Hz, and 48 Hz) except the maximum driving frequency of the display panel DP (e.g., in case that a driving frequency is 240 Hz), a display scan operation DISPLAY SCAN may be performed in a frame (e.g., single frame) and a self-scan operation SELF SCAN may be performed in at least one frame.

Specifically, in case that the driving frequency is 120 Hz, a display scan operation DISPLAY SCAN of a frame (e.g., single frame) and a self-scan operation SELF SCAN of a frame (e.g., single frame) may be repeated. A display scan operation DISPLAY SCAN of a frame (e.g., single frame) and a self-scan operation SELF SCAN of a frame (e.g., single frame) may constitute a driving frame (i.e., the same image may be displayed during a driving frame, e.g., single driving frame). In case that the driving frequency is 80 Hz, a display scan operation DISPLAY SCAN of a frame (e.g., single frame) and a self-scan operation SELF SCAN of two frames may be repeated. A display scan operation DISPLAY SCAN of a frame (e.g., single frame) and a self-scan operation SELF SCAN of two frames may constitute a driving frame (e.g., single driving frame). In case that the driving frequency is 60 Hz, a display scan operation DISPLAY SCAN of a frame (e.g., single frame) and a self-scan operation SELF SCAN of three frames may be repeated. A display scan operation DISPLAY SCAN of a frame (e.g., single frame) and a self-scan operation SELF SCAN of three frames may constitute a driving frame (e.g., single driving frame). In case that the driving frequency is 48 Hz, a display scan operation DISPLAY SCAN of a frame (e.g., single frame) and a self-scan operation SELF SCAN of four frames may be repeated. A display scan operation DISPLAY SCAN of a frame (e.g., single frame) and a self-scan operation SELF SCAN of four frames may constitute a driving frame (e.g., single driving frame).

As such, the controller 150 may vary the driving frequency in a manner that adjusts the length of the self-scan operation SELF SCAN.

Referring to FIGS. 3 to 6, a frame FR may include a first sub-frame SF1 and at least a second sub-frame SF2. A data voltage VDATA may be written in the first sub-frame of the frame FR in which a display scan operation DISPAY SCAN is performed. The data voltage VDATA may not be written in the first sub-frame of the frame FR in which a self-scan operation SELF SCAN is performed. The light emitting element LD may emit light in the second sub-frame SF2.

In FIGS. 5 and 6, the number of second sub-frames SF2 in the frame FR is 2. However, the disclosure is not limited thereto.

Referring to FIGS. 3 to 5, the first sub-frame SF1 of the frame FR in which the display scan operation DISPLAY SCAN is performed may include a first initialization period IP1, a compensation period CP, a second initialization period IP2, and a write period WP.

In the first initialization period IP1, the fourth, eighth, and tenth transistors T4, T8, and T10 may be turned on. For example, in the first initialization period IP1, the first emission signal EM1[i] may have a low voltage level, and the initialization gate signal G1[i] may have a high voltage level. The first power voltage VDD may be applied to the second node N2, and the initialization voltage VAINT may be applied to the fourth node N4. Accordingly, the second capacitor C2 may be initialized. The second power voltage VSS may be applied to the anode electrode AE of the light emitting element LD. Accordingly, a voltage charged in the light emitting element LD may be discharged.

In the compensation period CP, the fourth, seventh, and tenth transistors T4, T7, and T10 may be turned on. For example, the first emission signal EM1[i] may have the low voltage level, and the second compensation gate signal GC2[i] may have the high voltage level. The voltage of the fourth node N4 may be charged up to a voltage that is lowered by a threshold voltage of the sixth transistor T6 from the first power voltage VDD. The first power voltage VDD may be applied to the second node N2, and the second power voltage VSS may be applied to the anode electrode AE of the light emitting element LD.

In the second initialization period IP2, the third, fourth, and tenth transistors T3, T4, and T10 may be turned on. For example, the first emission signal EM1[i] may have the low voltage level, and the first compensation gate signal GC1[i] may have the high voltage level. The first power voltage VDD may be applied to the first node N1. Accordingly, the first capacitor C1 may be initialized. The first power voltage VDD may be applied to the second node N2, and the second power voltage VSS may be applied to the anode electrode AE of the light emitting element LD.

In the write period WP, the second and third transistors T2 and T3 may be turned on, and the fourth and tenth transistors T4 and T10 may be turned off. For example, the first emission signal EM1[i] may have the high voltage level, and the first compensation gate signal GC1[i] and the write gate signal GW[i] may have the high voltage level. A data voltage VDATA may be applied to the third node N3, and a voltage of the first node N1 may be charged up to a voltage corresponding to the data voltage VDATA and a threshold voltage of the first transistor T1. Accordingly, the data voltage VDATA may be written in the first capacitor C1. A voltage of the fourth node N4 may be changed corresponding to a voltage change of the second node N2.

The second sub-frame SF2 of the frame FR may include a third initialization period IP3 and an emission period EP.

In the third initialization period IP3, the fourth and tenth transistors T4 and T10 may be turned on. For example, the first emission signal EM1[i] may have the low voltage level. The first power voltage VDD may be applied to the second node N2. The voltage of the fourth node N4 may be changed corresponding to the voltage change of the second node N2. The second power voltage VSS may be applied to the anode electrode AE of the light emitting element LD. Accordingly, the voltage charged in the light emitting element LD may be changed.

The sweep voltage SV may decrease before the emission period EP in the second sub-frame SF2. The voltage of the first node N1 may be changed corresponding to a voltage change of the sweep voltage SV.

In the emission period EP, the fifth and ninth transistors T5 and T9 may be turned on. For example, the second emission signal EM2[i] may have the low voltage level. The sweep voltage SV may gradually increase. The first transistor T1 may not generate the first driving current before the sweep voltage SV increases. As the sweep voltage SV increases, a voltage of the control electrode of the first transistor T1 may increase, and the first transistor T1 may generate the first driving current. As the first driving current flows through the first transistor T1, a voltage of the second node N2 decreases. As the voltage of the second node N2 decreases, a voltage of the control electrode of the sixth transistor T6 may decrease, and the sixth transistor T6 may generate the second driving current. The light emitting element LD may receive the second driving current to emit light.

A timing at which the first transistor T1 generates the first driving current may vary according to the data voltage VDATA written in the first capacitor C1. For example, as the data voltage VDATA becomes larger, the timing at which the first transistor T1 generates the first driving current may become faster. Accordingly, a timing at which the sixth transistor T6 generates the second driving current may also become faster. For example, the emission time of the light emitting element LD may vary according to the data voltage VDATA, and the light emitting element LD may express various grayscales according to an emission time.

Referring to FIGS. 3, 4, and 6, the data voltage VDATA may not be written in the first sub-frame SF1 of the frame FR during the self-scan operation SELF SCAN. For example, in the first sub-frame SF1 of the frame FR during the self-scan operation SELF SCAN, the first emission signal EM1[i] and the second emission signal EM2[i] may have the high voltage level, and the initialization gate signal G1[i], the first compensation gate signal GC1[i], the second compensation gate signal GC2[i], and the write gate signal GW[i] may have the low voltage level.

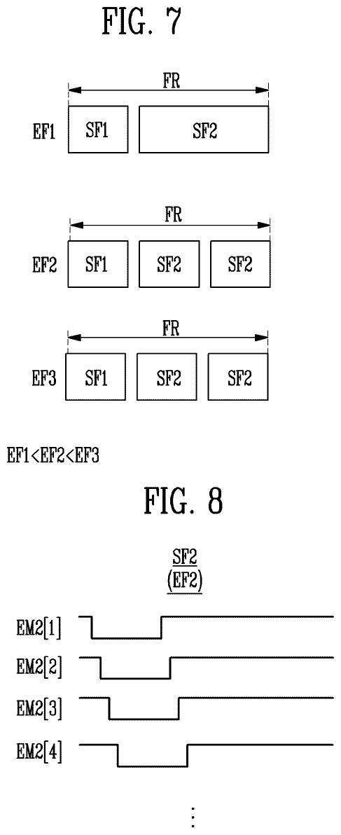

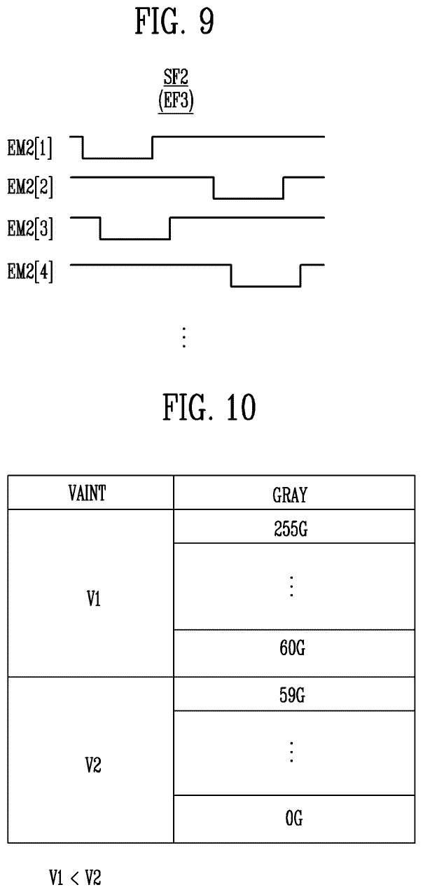

FIGS. 7 to 9 are schematic diagrams illustrating an example in which a display device controls an emission time according to an emission frequency in accordance with embodiments of the disclosure.

The display device in accordance with these embodiments is configured substantially identical to the display device shown in FIG. 1, except that the display device changes a number of second sub-frames according to an emission frequency, allows a first portion of rows to emit light according to the emission frequency and then allows a second portion of the rows to emit light. Therefore, identical or similar components are designated by like reference numerals, and overlapping descriptions will be omitted.

Referring to FIGS. 1 and 5 to 8, the controller 150 may increase an emission time of the frame FR according to an emission frequency. For example, the controller 150 may adjust a number of second sub-frames SF2 according to the emission frequency. In an embodiment, the emission frequency may be set by a user or be set according to a mode which the user sets. In an embodiment, the emission frequency may vary according to a peripheral illuminance of the display device. However, the disclosure is not limited to a method of determining the emission frequency.

The number of second sub-frames SF2 may become larger as the emission frequency becomes higher. For example, the number of second sub-frames SF2 in the frame FR of a first emission frequency EF1 may be 1, and the number of second sub-frames SF2 in the frame FR of a second emission frequency EF2 higher than the first emission frequency EF1 may be 2. For example, as the emission frequency becomes higher, a number of times the light emitting element LD emits light in the frame FR may increase, and an emission time in the frame FR may increase. Accordingly, a higher luminance may be viewed by the user with respect to the same data voltage VDATA.

The length of the first sub-frame SF1 may be constant, and the length of the second sub-frame SF2 may vary according to the number of second sub-frames SF2. However, although the length of the second sub-frame SF2 may be changed, a period (i.e., an emission time) in which the second emission signal EM2[i] in a second sub-frame SF2 has the low voltage level may be constant.

Referring to FIGS. 1, 5 to 7, and 9, in case that the emission frequency does not exceed a specific frequency, the controller 150 may allow rows including sub-pixels SP to sequentially emit light. In case that the emission frequency exceeds the specific frequency, the controller 150 may allow a first portion (e.g., an odd-numbered row) of the rows including the sub-pixels SP and then allow a second portion (e.g., an even-numbered row) of the rows including the sub-pixels SP to emit light.

For example, the controller 150 may sequentially apply second emission signals EM2[1], EM2[2], EM2[3], EM2[4], . . . having the low voltage level to the first to mth gate lines GL1 to GLm at the first emission frequency EF1 and the second emission frequency EF2. For example, at a third emission frequency EF3 higher than the second emission frequency EF2, the controller 150 may sequentially apply second emission signals EM2[1], EM2[3], . . . having the low voltage level to odd-numbered gate lines and then sequentially apply second emission signal EM2[2], EM2[4], . . . having the low voltage level to even-numbered gate lines.

For example, at the third emission frequency EF3, the controller 150 may use a period in which the second emission signal EM2[i] has the high voltage level at the second emission frequency EF2. Accordingly, although numbers of second sub-frames SF2 at the second emission frequency EF2 and the third emission frequency EF3 are the same, light may be viewed by the user as if the emission time is further increased at the third emission frequency EF3, and a higher luminance may be viewed by the user.

In these embodiments, both a method of changing the number of second sub-frames according to the emission frequency and a method of allowing the first portion of the rows to emit light and then allowing the second portion of the rows to emit light according to the emission frequency may be used. However, the disclosure may use only one of the two methods.

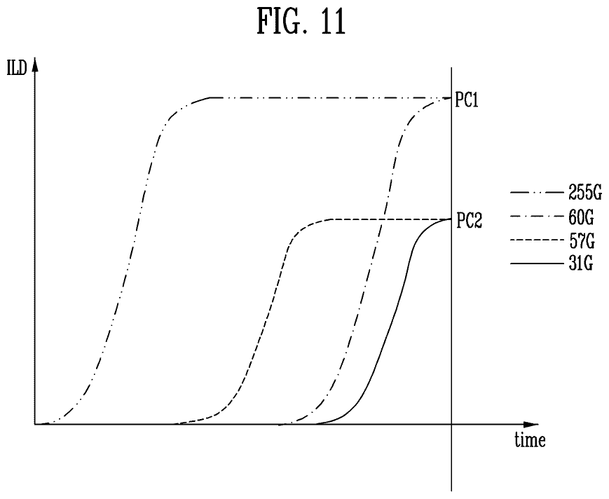

FIG. 10 is a table illustrating an example in which a display device adjusts an initialization voltage according to a grayscale in accordance with embodiments of the disclosure. FIG. 11 is a graph illustrating an example of a second driving current according to the grayscale shown in FIG. 10.

The display device in accordance with these embodiments is configured substantially identical to the display device shown in FIG. 1, except that the display device adjusts the initialization voltage VAINT. Therefore, identical or similar components are designated by like reference numerals, and overlapping descriptions will be omitted.

Referring to FIGS. 10 and 11, the initialization voltage VAINT may be determined according to a grayscale GRAY. For example, in case that the grayscale GRAY has a first grayscale (e.g., grayscale 60G to grayscale 255G), the initialization voltage VAINT may have a first voltage V1. In case that the grayscale GRAY has a second grayscale (e.g., grayscale OG to grayscale 59G), the initialization voltage VAINT may have a second voltage V2 higher than the first voltage V1.

As the initialization voltage VAINT becomes higher, a peak current of a second driving current ILD may become smaller. For example, as shown in FIG. 11, a peak current at a grayscale (e.g., the grayscale 255G and the grayscale 60G) at which the initialization voltage VAINT is the first voltage V1 may be a first peak current PC1, and a peak current at a grayscale (e.g., the grayscale 57G and the grayscale 31G) at which the initialization voltage VAINT is the second voltage V2 may be a second peak current PC2 smaller than the first peak current PC1. In case that peak currents at all grayscales are the same, the second driving current ILD at a low grayscale may not reach the peak current. In case that the second driving current ILD does not reach the peak current, advantages of the PWM method may disappear. Therefore, the initialization voltage VAINT may increase at a low grayscale, so that the second driving current ILD can reach a peak current even at the low grayscale.

In these embodiments, it is illustrated that the initialization voltage VAINT may be changed by being divided into two sections. However, the disclosure is not limited thereto.

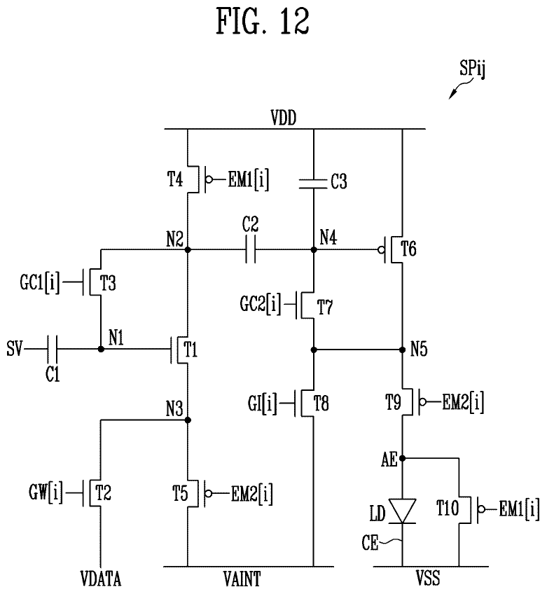

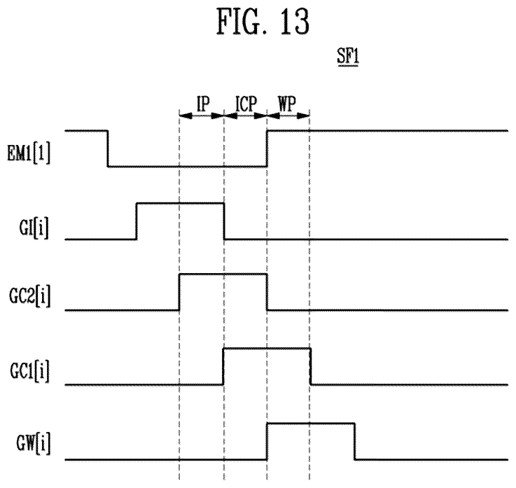

FIG. 12 is a schematic diagram of an equivalent circuit of any one of sub-pixels of a display device in accordance with embodiments of the disclosure. FIG. 13 is a schematic timing diagram illustrating an example in which the display device shown in FIG. 12 drives a first sub-frame of a frame in which a display scan operation may be performed.

The display device in accordance with these embodiments is configured substantially identical to the display device shown in FIG. 1, except a seventh transistor T7 and a first sub-frame SF1 of a frame in which a display scan operation DISPLAY SCAN (see FIG. 4) may be performed. Therefore, identical or similar components are designated by like reference numerals, and overlapping descriptions will be omitted.

Referring to FIG. 12, the sub-pixel SPij may include a seventh transistor T7 including a control electrode receiving the second compensation gate signal GC2[i], a first electrode to the fourth node N4. Accordingly, a transistor (e.g., single transistor) is connected to the control electrode of the sixth transistor T6, and thus a leakage current through the transistor connected to the control electrode of the sixth transistor T6 can be reduced.

Referring to FIGS. 12 and 13, the first sub-frame SF1 of the frame FR, in which the display scan operation DISPLAY SCAN is performed may include an initialization period IP, an initialization compensation period ICP, and a write period WP.

In the initialization period IP, the fourth, seventh, eighth, and tenth transistors T4, T7, T8, and T10 may be turned on. For example, in the initialization period IP, the first emission signal EM1[i] may have the low voltage level, and the initialization gate signal G1[i] and the second compensation gate signal GC2[i] may have the high voltage level. The first power voltage VDD may be applied to the second node N2, and the initialization voltage VAINT may be applied to the fourth node N4. Accordingly, the second capacitor C2 may be initialized. The second power voltage VSS may be applied to the anode electrode AE of the light emitting element LD. Accordingly, the voltage charged in the light emitting element LD may be discharged.

In the initialization compensation period ICP, the third, fourth, seventh, and the tenth transistors T3, T4, T7, and T10 may be turned on. For example, the first emission signal EM1[i] may have the low voltage level, and the first compensation gate signal GC1[i] and the second compensation gate signal GC2[i] may have the high voltage level. The voltage of the fourth node N4 may be charged up to a voltage that is lowered by a threshold voltage of the sixth transistor T6 from the first power voltage VDD. The first power voltage VDD may be applied to the first node N1. Accordingly, the first capacitor C1 may be initialized. The first power voltage VDD may be applied to the second node N2, and the second power voltage VSS may be applied to the anode electrode AE of the light emitting element LD.

In the write period WP, the second and third transistors T2 and T3 may be turned on, and the fourth and tenth transistors T4 and T10 may be turned off. For example, the first emission signal EM1[i] may have the high voltage level, and the first compensation gate signal GC1[i] and the write gate signal GW[i] may have the high voltage level. The data voltage VDATA may be applied to the third node N3, and the voltage of the first node N1 may be charged up to the voltage corresponding to the data voltage VDATA and the threshold voltage of the first transistor T1. Accordingly, the data voltage VDATA may be written in the first capacitor C1. The voltage of the fourth node N4 may be changed corresponding to the voltage change of the second node N2.

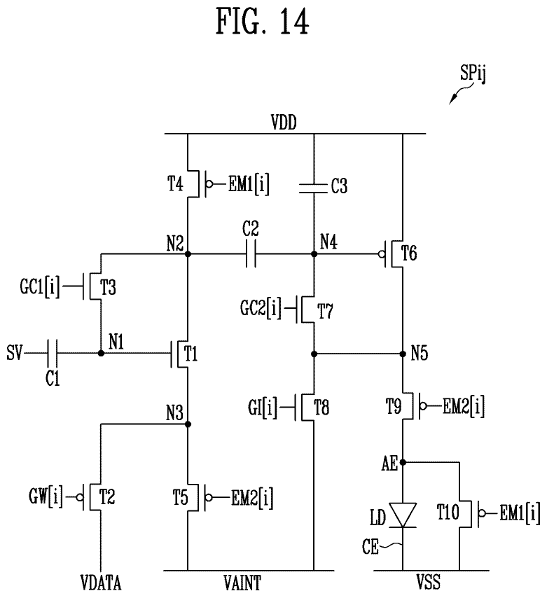

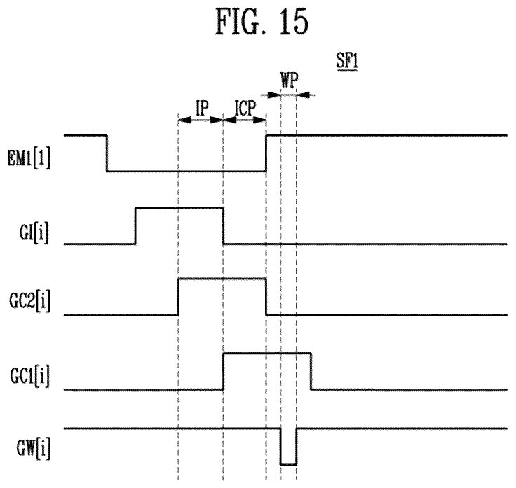

FIG. 14 is a schematic diagram of an equivalent circuit of any one of sub-pixels of a display device in accordance with embodiments of the disclosure. FIG. 15 is a schematic timing diagram illustrating an example in which the display device shown in FIG. 14 drives a first sub-frame of a frame in which a display scan operation may be performed.

The display device in accordance with these embodiments is configured substantially identical to the display device shown in FIG. 1, except that the second transistor T2 may be a P-type transistor. Therefore, identical or similar components are designated by like reference numerals, and overlapping descriptions will be omitted.

Referring to FIGS. 14 and 15, the second transistor T2 may be a P-type transistor. Accordingly, a write speed of the data voltage VDATA may become fast. As the second transistor T2 may be a P-type transistor, the write gate signal GW[i] may have the low voltage level in the write period WP.

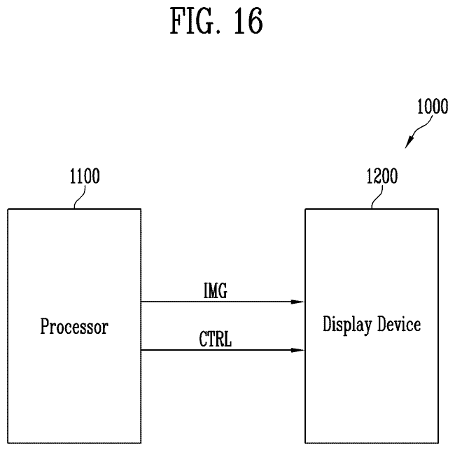

FIG. 16 is a schematic block diagram illustrating an embodiment of a display system.

Referring to FIG. 16, a display system 1000 may include a processor 1100 and a display device 1200.

The processor 1100 may perform various tasks and various calculations. In embodiments, the processor 1100 may include an Application Processor (AP), a Graphics Processing Unit (GPU), a microprocessor, a Central Processing Unit (CPU), and the like. The processor 1100 may be connected to other components of the display system 1000 through a bus system to control the components of the display system 1000.

The processor 1100 may transmit image data IMG and a control signal CTRL to the display device 1200. The display device 1200 may display an image, based on the image data IMG and the control signal CTRL. The display device 1200 may be configured identical to the display device DD described with reference to FIG. 1. The image data IMG and the control signal CTRL may be provided as the input image data IMG and the control signal CTRL, which are shown in FIG. 1, respectively.

The display system 1000 may include a computing system for providing an image display function, such as a smart watch, a mobile phone, a smartphone, a portable computer, a tablet personal computer (PC), a watch phone, an automotive display, a smart glass, a portable multimedia player (PMP), a navigation system, or an ultra mobile computer (UMPC). The display system 1000 may include at least one of a head mounted display (HMD) device, a virtual reality (VR) device, a mixed reality (MR) device, and an augmented reality (AR) device.

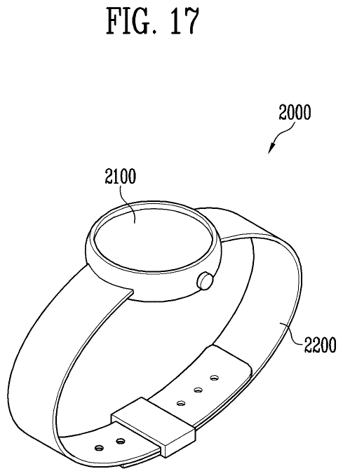

FIGS. 17 to 20 are perspective views illustrating application examples of the display system shown in FIG. 16.

Referring to FIG. 17, the display system 1000 shown in FIG. 16 may be applied to a smart watch 2000 including a display part 2100 and a strap part 2200.

The smart watch 2000 may be a wearable electronic device. For example, the smart watch 2000 may have a structure in which the strap part 2200 may be mounted on a wrist of a user. The display system 1000 and/or the display device 1200 may be applied to the display part 2100, so that image data including time information can be provided to the user.

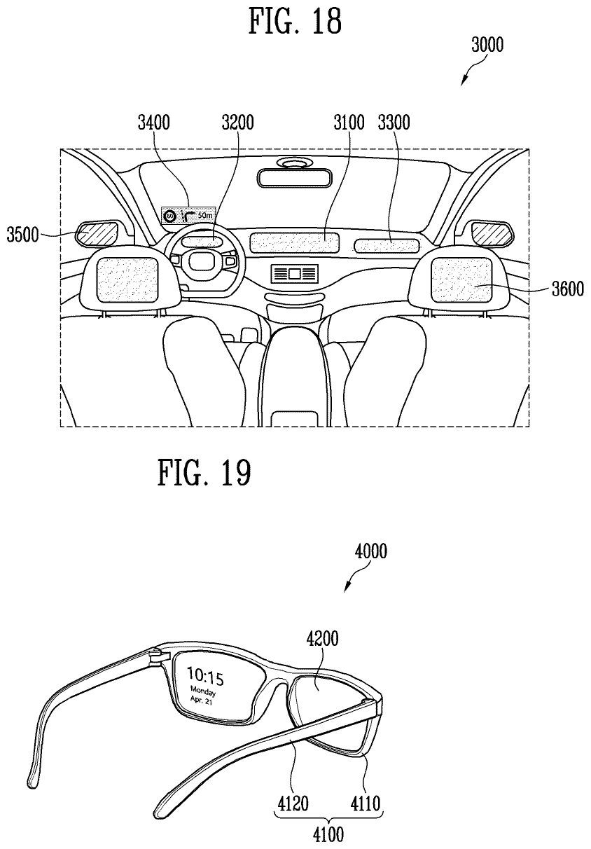

Referring to FIG. 18, the display system 1000 shown in FIG. 16 may be applied to an automotive display system 3000. The automotive display system 3000 may include a computing system provided at the inside/outside of a vehicle to provide image data.

For example, the display system 1000 and/or the display device 1200 may be applied to at least one of an infortainment panel 3100, a cluster 3200, a co-driver display 3300, a head-up display 3400, a side mirror display 3500, and a read seat display 3600, which may be provided in the vehicle.

Referring to FIG. 19, the display system 1000 shown in FIG. 16 may be applied to smart glasses 4000. The smart glasses 4000 may be a wearable electronic device which can be worn on the face of a user. For example, the smart glasses 4000 may be a wearable device for Augmented Reality (AR).

The smart glasses 4000 may include a frame 4100 and a lens part 4200. The frame 4100 may include a housing 4110 supporting the lens part 4200 and a leg part 4120 for allowing the user to wear the smart glasses 4000. The leg part 4120 may be connected to the housing 4110 through a hinge, to be folded or unfolded with respect to the housing 4110.

A battery, a touch pad, a microphone, a camera, and the like may be built in the frame 4100. For example, a projector for outputting light, a processor for controlling a light signal, and the like may be built in the frame 4100.

The lens part 4200 may be an optical member which allows light to be transmitted therethrough or allows light to be reflected thereby. For example, the lens part 4200 may include glass, transparent synthetic resin, and the like.

In order to enable eyes of the user to recognize visual information, the lens part 4200 may allow an image caused by a light signal transmitted from the projector of the frame 4100 to be reflected by a rear surface (e.g., a surface in a direction facing the eyes of the user) of the lens part 4200. For example, the user may recognize information including time, data, and the like, which is displayed on the lens part 4200. The projector and/or the lens part 4200 may be a kind of display device. The display device 1200 may be applied to the projector and/or the lens part 4200.

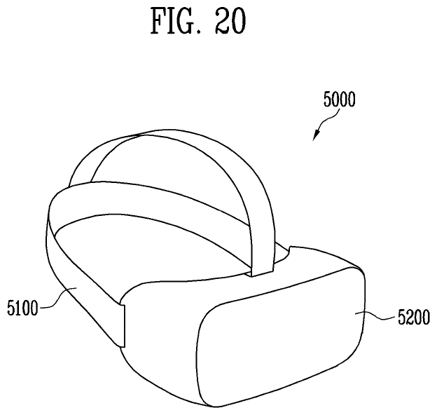

Referring to FIG. 20, the display system 1000 shown in FIG. 16 may be applied to a head mounted display device 5000.

The head mounted display device 5000 may be a wearable electronic device which can be worn on the head of a user. For example, the head mounted display device 5000 may be a wearable device for virtual reality (VR) or mixed reality (MR).

The head mounted display device 5000 may include a head mounted band 5100 and a display accommodating case 5200. The head mounted band 5100 may be connected to the display accommodating case 5200. The head mounted band 5100 may include a horizontal band and/or a vertical band, used to fix the head mounted display device 5000 to the head of the user. The horizontal band may be configured to surround a side portion of the head of the user, and the vertical band may be configured to surround an upper portion of the head of the user. However, embodiments are not limited thereto. For example, the head mounted band 5100 may be implemented in the form of a glasses frame, a helmet or the like.

The display accommodating case 5200 may accommodate the display system 1000 and/or the display device 1200.

The disclosure can be applied to display devices and electronic devices including the same. For example, the disclosure can be applied to digital TVs, 3D TVs, mobile phones, smart phones, tablet computers, VR devices, PCs, home appliances, notebook computers, PDAs, PMPs, digital cameras, music players, portable game consoles, navigation systems, and the like.

In accordance with the disclosure, the sub-pixel may be driven with only a small number of transistors, using the PWM method, so that a high pixel per inch (PPI) can be secured.

In the sub-pixel in accordance with the disclosure, the first transistor may be used as an N-type transistor, and a source electrode of the sixth transistor may be fixed to the first power voltage so that a luminance change caused by hysteresis characteristics can be minimized.

In the sub-pixel in accordance with the disclosure, the third transistor and seventh transistor may be implemented as an N-type transistor so that a leakage current can be reduced.

In the sub-pixel in accordance with the disclosure, a change in the second driving current due to an IR drip of the first power voltage can be compensated through the third capacitor.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the disclosure as set forth in the following claims.

What is claimed is:

1. A sub-pixel comprising:
a first transistor generating a first driving current corresponding to a data voltage;
a first capacitor including a first electrode receiving a sweep voltage and a second electrode connected to a control electrode of the first transistor;
a driving transistor generating a second driving current;
a second capacitor including a first electrode connected to the first transistor and a second electrode connected to a control electrode of the driving transistor; and
a light emitting element receiving the second driving current to emit light.

2. The sub-pixel of claim 1, further comprising:
a second transistor providing the data voltage to the first transistor in response to a write gate signal;
a third transistor allowing the first transistor to be diode-connected in response to a first compensation gate signal;
a fourth transistor providing a first power voltage to the first transistor in response to a first emission signal; and
a reset transistor providing an initialization voltage to the first transistor in response to a second emission signal.

3. The sub-pixel of claim 2, wherein
the first transistor includes the control electrode connected to the first capacitor, a first electrode connected to the second capacitor, and a second electrode,
the second transistor is connected to the second electrode of the first transistor,
the third transistor is connected to the control electrode of the first transistor and the first electrode of the first transistor,
the fourth transistor is connected to the first electrode of the first transistor, and
the reset transistor is connected to the second electrode of the first transistor.

4. The sub-pixel of claim 2, wherein the second transistor is an N-type transistor.

5. The sub-pixel of claim 2, wherein the second transistor is a P-type transistor.

6. The sub-pixel of claim 2, wherein the third transistor is an N-type transistor.

7. The sub-pixel of claim 1, further comprising:
a compensation transistor allowing the driving transistor to be diode-connected in response to a second compensation gate signal;
an initialization transistor providing an initialization voltage to the driving transistor in response to an initialization gate signal;
an emission control transistor connecting the driving transistor to the light emitting element in response to a second emission signal; and
a discharge transistor providing a second power voltage to an anode electrode of the light emitting element in response to a first emission signal.

8. The sub-pixel of claim 7, wherein
the driving transistor includes the control electrode connected to the second capacitor, a first electrode receiving a first power voltage, and a second electrode,
the compensation transistor is connected to the control electrode of the driving transistor and the second electrode of the driving transistor, and
the initialization transistor is connected to the control electrode of the driving transistor.

9. The sub-pixel of claim 7, wherein
the driving transistor includes the control electrode connected to the second capacitor, a first electrode receiving a first power voltage, and a second electrode,
the compensation transistor is connected to the control electrode of the driving transistor and the second electrode of the driving transistor, and
the initialization transistor is connected to the second electrode of the driving transistor.

10. The sub-pixel of claim 7, wherein the compensation transistor is an N-type transistor.

11. The sub-pixel of claim 1, wherein
the first transistor is an N-type transistor, and
the driving transistor is a P-type transistor.

12. The sub-pixel of claim 1, further comprising:
a third capacitor including a first electrode receiving a first power voltage and a second electrode connected to the control electrode of the driving transistor.

13. A display device comprising:
a display panel including at least one sub-pixel; and
a display panel driver configured to drive the display panel,
wherein each of the at least one sub-pixel includes:
a first transistor generating a first driving current corresponding to a data voltage;
a first capacitor including a first electrode receiving a sweep voltage and a second electrode connected to a control electrode of the first transistor;
a driving transistor generating a second driving current;
a second capacitor including a first electrode connected to the first transistor and a second electrode connected to a control electrode of the driving transistor; and
a light emitting element receiving the second driving current to emit light.

14. The display device of claim 13, wherein each of the at least one sub-pixel further includes:
a reset transistor providing an initialization voltage to the first transistor in response to a second emission signal; and
an initialization transistor providing the initialization voltage to the driving transistor in response to an initialization gate signal, and
wherein the initialization voltage is determined according to a grayscale.

15. The display device of claim 14, wherein
the initialization voltage has a first voltage in case that the grayscale has a first grayscale; and
the initialization voltage has a second voltage higher than the first voltage in case that the grayscale has a second grayscale smaller than the first grayscale.

16. The display device of claim 13, wherein
a frame includes a first sub-frame and at least one second sub-frame,
the light emitting element emits light in the at least one second sub-frame, and
a number of the at least one second sub-frame is determined according to an emission frequency.

17. The display device of claim 13, wherein
the at least one sub-pixel includes a plurality of sub-pixels, the plurality of sub-pixels being arranged in a plurality of rows, and
the display panel driver is configured to allow ones of the plurality of sub-pixels disposed in a first portion of the plurality of rows to emit light and then allow ones of the plurality of sub-pixels disposed in a second portion of the plurality of rows to emit light.

18. The display device of claim 13, wherein
the at least one sub-pixel includes a plurality of sub-pixels, the plurality of sub-pixels being disposed in a plurality of rows,
the display panel driver is configured to allow the plurality of sub-pixels included in the plurality of rows to sequentially emit light at a first emission frequency; and
the display panel driver is further configured to allow ones of the plurality of sub-pixels disposed in a first portion of the plurality of rows to emit light and then allow ones of the plurality of sub-pixels disposed in a second portion of the plurality of rows to emit light at a second emission frequency higher than the first emission frequency.

19. The display device of claim 13, wherein each of the at least one sub-pixel includes:
a second transistor providing the data voltage to the first transistor in response to a write gate signal;
a third transistor allowing the first transistor to be diode-connected in response to a first compensation gate signal;
a fourth transistor providing a first power voltage to the first transistor in response to a first emission signal;
a reset transistor providing an initialization voltage to the first transistor in response to a second emission signal;
a compensation transistor allowing the driving transistor to be diode-connected in response to a second compensation gate signal;
an initialization transistor providing the initialization voltage to the driving transistor in response to an initialization gate signal;
an emission control transistor connecting the driving transistor to the light emitting element in response to the second emission signal; and
a discharge transistor providing a second power voltage to an anode electrode of the light emitting element in response to the first emission signal.

20. The display device of claim 19, wherein the at least one sub-pixel further includes a third capacitor including a first electrode receiving the first power voltage and a second electrode connected to the control electrode of the driving transistor.
